(19) United States
(12) Patent Application Publication
(10) Pub. No.: US 2018/0127619 A1
(43) Pub. Date: May 10, 2018

(54) ADHESIVE TAPE AND WIRE HARNESS HAVING ADHESIVE TAPE

(71) Applicant: Yazaki Corporation, Tokyo (JP)

(72) Inventor: Kazuya TAKEUCHI, Shizuoka (JP)

(73) Assignee: Yazaki Corporation, Tokyo (JP)

(21) Appl. No.: 15/789,054

(22) Filed: Oct. 20, 2017

(30) Foreign Application Priority Data
Nov. 8, 2016 (JP) 2016-218080

(51) Int. Cl. C09J 7/02; H01B 7/00; H01B 7/02

(52) U.S. Cl. CPC C09J 7/0278; C09J 133/20; H01B 7/0216; H01B 7/0045

(57) ABSTRACT

An adhesive tape includes a supporting body containing polyvinyl chloride and an adhesive layer containing a (meth)acrylic polymer, a rubber polymer, and tackifier resin. In the adhesive tape, the degree of polymerization of polyvinyl chloride is between 1250 and 1800 inclusive, and the (meth)acrylic polymer contains no nitrogen atoms. The (meth)acrylic polymer contains a structural unit derived from at least a type of monomer selected from the group consisting of methyl acrylate, ethyl acrylate, 2-ethylhexyl acrylate, butyl acrylate, 2-hydroxyethyl acrylate, methyl methacrylate, and 2-hydroxyethyl methacrylate.

### CROSS-REFERENCE TO RELATED APPLICATION(S)

The present application claims priority to and incorporates by reference the entire contents of Japanese Patent Application No. 2016-218080 filed in Japan on Nov. 8, 2016.

### BACKGROUND OF THE INVENTION

### 1. Field of the Invention

The present invention relates to an adhesive tape and a wire harness having the adhesive tape.

### 2. Description of the Related Art

A number of covered electric wires are used for wiring inside a vehicle. The covered electric wires are usually used as a wire harness by being bundled with an adhesive tape wound therearound. For the adhesive tape, Japanese Patent Application Laid-open No. 2000-345121 describes a polyvinyl chloride (PVC) adhesive tape configured with a supporting body made of vinyl chloride resin and an adhesive layer made of an adhesive agent. More specifically, a polyester plasticizer is used for the vinyl chloride resin, and a primer layer made of polyurethane latex is interposed between the supporting body and the adhesive layer.

Some wire harnesses are routed on places exposed to high temperatures for a long time such as an engine room. When the PVC adhesive tape described in Japanese Patent Application Laid-open No. 2000-345121 is used for a wire harness and exposed to high temperatures for a long time in an engine room, the PVC adhesive tape discolors. Adhesive tapes used for home appliances and mechanical products may discolor when used in an environment exposed to high temperatures for a long time.

### SUMMARY OF THE INVENTION

To overcome the above-described problems, the present invention aims to provide an adhesive tape less discoloring even when exposed to high temperatures for a long time.

According to one aspect of the present invention, an adhesive tape includes a supporting body containing polyvinyl chloride; and an adhesive layer containing a (meth)acrylic polymer, a rubber polymer, and tackifier resin, wherein a degree of polymerization of the polyvinyl chloride is between 1250 and 1800 inclusive, and the (meth)acrylic polymer contains no nitrogen atoms.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWING

FIG. 1 is an illustrative drawing of an adhesive tape according to an embodiment.

### DETAILED DESCRIPTION OF THE PREFERRED EMBODIMENTS

Embodiments of the present invention will now be described in detail with reference to the drawing. It should be noted that the described embodiments are not intended to limit the scope of the present invention. Components in the following description include what the skilled person could have easily thought of and what is substantially the same. Configurations in the following description can be combined with one another at appropriate. Various omissions, substitutions, and changes can be made on the configurations without departing from the spirit of the present invention.

Adhesive Tape

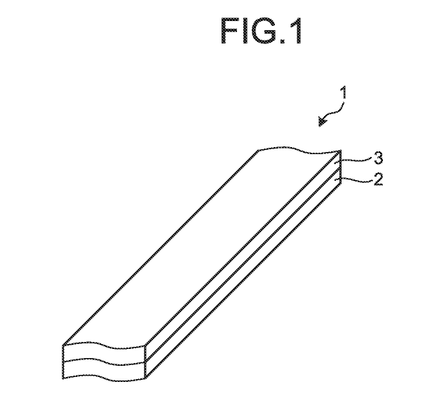

FIG. 1 is an illustrative drawing of an adhesive tape according to an embodiment. An adhesive tape 1 in this embodiment includes a supporting body 2 containing polyvinyl chloride and an adhesive layer 3 containing a (meth)acrylic polymer, a rubber polymer, and tackifier resin. The adhesive layer 3 is laminated on the supporting body 2. The degree of polymerization of polyvinyl chloride is between 1250 and 1800 inclusive, and the (meth)acrylic polymer contains no nitrogen atoms. Inclusion of the (meth)acrylic polymer containing nitrogen atoms in the adhesive layer may accelerate discoloration (usually a change from brown to black) of the adhesive tape under high temperatures. This phenomenon is considered to be caused due to interaction of the (meth)acrylic polymer containing nitrogen atoms and polyvinyl chloride contained in the supporting body under high temperatures. Even when a (meth)acrylic polymer containing no nitrogen atoms is used, discoloration of the adhesive tape may accelerate under high temperatures depending on the degree of polymerization of polyvinyl chloride. To overcome this problem, use of a (meth)acrylic polymer containing no nitrogen atoms for a material of the adhesive layer 3 and use of polyvinyl chloride having a certain degree of polymerization for a material of the supporting body 2 can make the adhesive tape 1 less discoloring despite being exposed to high temperatures for a long time. In this description, being exposed to high temperatures for a long time not only includes being exposed to high temperatures at a time but also includes repeatedly undergoing heat histories from a low temperature (for example, a room temperature or a temperature lower than the room temperature) to a high temperature, which results in a large amount of the total exposure time under high temperatures.

Supporting Body

The supporting body 2 contains polyvinyl chloride and is usually formed of a flexible vinyl chloride film. The supporting body 2 may further contain a known additive such as pigments, fillers, stabilizers, and plasticizers.

Polyvinyl chloride contained in the supporting body 2 is a homopolymer of vinyl chloride or a copolymer of vinyl chloride and another monomer. Examples of the copolymer include an ethylene-vinyl chloride copolymer and a propylene-vinyl chloride copolymer. The copolymer usually contains structural units derived from vinyl chloride in an amount of equal to or greater than 50 mol % and less than 100 mol % with all the structural units of the copolymer taken as 100 mol %. Polyvinyl chloride may be used singly or in mixture of two or more types.

The degree of polymerization of polyvinyl chloride is between 1250 and 1800 inclusive. This range of degree of polymerization can prevent discoloration of the adhesive tape 1 despite being exposed to high temperatures for a long time. The degree of polymerization is a value (the average degree of polymerization) measured in accordance with JIS K6720.

A pigment is used to make the adhesive tape 1 in a desired color. Examples of the pigment (more specifically, a pigment other than a white pigment) include C.I. Pigment Red 166, C.I., Pigment yellow 83, C.I. Pigment Yellow 13, and C.I. Pigment Yellow 183. Examples of the filler include calcium oxide, aluminum hydroxide, magnesium hydroxide, clay, and titanium oxide. Examples of the filler further include a chemical compound having a function of a white pigment. Each of the pigment and the filler may be used singly or in mixture of two or more types.

As described later, the adhesive tape 1 is preferably orange or yellow. More specifically, in color evaluation using L*, a*, b* system (CIE colorimetric system), the orange color preferably has L*between 40 and 70 inclusive, a* between 35 and 60 inclusive, and b* between 30 and 60 inclusive, whereas the yellow color preferably has L* between 70 and 90 inclusive, between −5 and 5 inclusive, and b* between 70 and 90 inclusive. For example, when making the adhesive tape 1 in orange, C.I. Pigment Red 166, C.I. Pigment yellow 83, and others are preferably used. When making the adhesive tape 1 in yellow, C.I. Pigment Yellow 13, C.I. Pigment Yellow 183, and others are preferably used.

Examples of the stabilizer include a lead, barium-zinc, calcium-zinc, and tin stabilizer. The stabilizer may be used singly or in mixture of two or more types. Examples of the plasticizer include a phthalate ester plasticizer, a trimellitate ester plasticizer, and a polyester plasticizer. The polyester plasticizer is a polymeric plasticizer containing a number of ester couplings in a single molecule. The plasticizer may be used singly or in mixture of two or more types.

It is also preferable that the supporting body 2 contain no anti-aging agents. Even with the supporting body 2 containing no anti-aging agents, the adhesive tape 1 less discolors when exposed to high temperatures for a long time. In this description, the anti-aging agent is an organic chemical compound added in order to inhibit or delay the aging process that decreases performance of a polymeric material with changes in physical properties and chemical properties of the polymeric material due to environmental factors for the polymeric material and the time course. Examples of the anti-aging agent include phenol anti-aging agents (hindered phenol antioxidants) such as tetrakis-[methylene-3-(3′,5′-di-tert-butyl-4′-hydroxyphenyl) propionate] methane and octadecyl-3-(3,5-di-tert-butyl-4-hydroxyphenyl) propionate, and amine anti-aging agents (aromatic amine antioxidants) such as 4,4′-dioctyldiphenylamine and N-phenyl-N′-1,3-dimethylbutyl-p-phenylenediamine. In particular, it is preferable that the supporting body 2 contain no phenol anti-aging agents (hindered phenol antioxidants).

The amount of polyvinyl chloride to be used is, for example, equal to or greater than 30% by mass, preferably equal to or greater than 40% by mass, and more preferably between 50% and 70% inclusive by mass, for the total amount of compositions constituting the supporting body 2. The remaining portion is for known additives such as pigments, fillers, stabilizers, and plasticizers. In order to make the adhesive tape 1 orange as described above, it is preferable to use, for 100 parts by mass of polyvinyl chloride, MXOE-1065 of Dainichiseika Color & Chemicals Mfg. Co., Ltd. in an amount of between one and three parts inclusive by mass and calcium carbonate in an amount of between 0.1 and 30 parts inclusive by mass.

The supporting body 2 usually has a thickness of between 0.05 mm and 0.20 mm inclusive, and preferably between 0.06 mm and 0.15 mm inclusive. With a thickness of less than 0.05 mm, the adhesive tape 1 is likely to be broken and cause problems in working with the tape. With a thickness over 0.20 mm, the adhesive tape 1 may come to be hardened and have difficulty in being wound, and covered electric wires having the adhesive tape 1 wound therearound may come to be less flexible and have difficulty in being bent.

Adhesive Layer

The adhesive layer 3 contains a (meth)acrylic polymer and a rubber polymer each serving as an adhesive agent, and tackifier resin. The adhesive layer 3 may further contain known additives such as anti-aging agents, thickeners, softeners, fillers, and water-resistant additives.

The (meth)acrylic polymer contained in the adhesive layer 3 contains no nitrogen atoms. Specifically, no nitrogen atoms is contained in polymer molecules of the (meth)acrylic polymer. Use of this (meth)acrylic polymer prevents the adhesive tape 1 from discoloring despite being exposed to high temperatures for a long time.

More specifically, the (meth)acrylic polymer preferably contains a structural unit derived from monomers containing no nitrogen atoms and more preferably consists of only structural units derived from monomers containing no nitrogen atoms. More specifically, the (meth)acrylic polymer contains no structural units derived from monomers containing nitrogen atoms such as acrylonitrile and acrylamide. Such a (meth)acrylic polymer may be used singly or in mixture of two or more types.

For an increase in adhesivity of the adhesive tape 1, methyl acrylate, ethyl acrylate, 2-ethylhexyl acrylate, butyl acrylate, 2-hydroxyethyl acrylate, methyl methacrylate, and 2-hydroxyethyl methacrylate are preferably used as monomers containing no nitrogen atoms. Such a monomer containing no nitrogen atoms may be used singly or in mixture of two or more types. Out of these monomers, combining 2-ethylhexyl acrylate, butyl acrylate, and methyl methacrylate is more preferable for a further increase in adhesivity of the adhesive tape 1.

The (meth)acrylic polymer preferably contains structural units derived from 2-ethylhexyl acrylate in an amount of between 30% and 50% inclusive by mass, structural units derived from butyl acrylate in an amount of between 30% and 50% inclusive by mass, and structural units derived from methyl methacrylate in an amount of between 10% and 40% inclusive by mass with the total amount of all the structural units derived from 2-ethylhexyl acrylate, butyl acrylate, and methyl methacrylate taken as 100% by mass. With the amounts of structural units in the above-described ranges, adhesivity of the adhesive tape 1 can be further increased.

Moreover, use of a (meth)acrylic polymer and a rubber polymer in combination can increase adhesivity of the adhesive tape 1. Such an adhesive tape 1 is therefore obtained that less discolors despite being exposed to high temperatures for a long time and has larger adhesivity. Examples of the rubber polymer include natural rubber and synthetic rubber such as isoprene rubber, styrene-butadiene rubber (SBR), and butyl rubber. Out of these kinds of rubber, natural rubber is preferably used for easier fabrication of the adhesive layer 3. Examples of the natural rubber include concentrated natural rubber and peroxide-prevulcanized natural rubber, and more preferably, concentrated natural rubber is used from an industrial viewpoint. The rubber polymer may be used singly or in mixture of two or more types.

Tackifier resin is used for an increase in adhesivity of the adhesive tape 1. Examples of the tackifier resin include rosin derivatives such as rosins and rosin ester resin, petroleum-based resin such as aliphatic petroleum-based resin and aromatic petroleum-based resin, terpene resin, and alkylphenol resin. The tackifier resin may be used singly or in mixture of two or more types.

The anti-aging agent is used for inhibiting oxidation of an adhesive material caused by heat and controlling a reduction in adhesivity. Examples of the anti-aging agent include phenol anti-aging agents (phenol antioxidants). The anti-aging agent may be used singly or in mixture of two or more types.

Examples of the thickener include copolymers of (meth)acrylic acid and (meth)acrylic acid ester, and polyacrylate thickeners such as sodium polyacrylate. The thickener may be used singly or in mixture of two or more types.

Each of the softener, the filler, and the water resistant additive may be used singly or in mixture of two or more types.

The adhesive layer 3 preferably includes a (meth)acrylic polymer in an amount of between 10% and 30% inclusive by mass, a rubber polymer in an amount of between 30% and 50% inclusive by mass, and tackifier resin in an amount of between 30% and 50% inclusive by mass with the total amount of the (meth)acrylic polymer, the rubber polymer, and the tackifier resin taken as 100% by mass. Containing the above-described amounts of the (meth)acrylic polymer, the rubber polymer, and the tackifier resin can increase adhesivity of the adhesive tape 1. The anti-aging agent is preferably contained in an amount of between 0.1 part and ten parts inclusive by mass with the total amount of the (meth)acrylic polymer, the rubber polymer, and the tackifier resin taken as 100 parts by mass. The tackifier resin is preferably contained in an amount of between 0.1 part and five parts inclusive by mass with the total amount of the (meth)acrylic polymer, the rubber polymer, and the tackifier resin taken as 100 parts by mass. Known additives such as a softener, a filler, and a water resistant additive may be contained in respective amounts without limiting the advantageous effects of the embodiment.

The adhesive layer 3 usually has a thickness of between 0.001 mm and 0.05 mm inclusive, preferably between 0.005 mm and 0.02 mm inclusive. A thickness of smaller than 0.001 mm may cause insufficient adhesivity of the adhesive layer 3. On the other hand, a thickness of larger than 0.05 mm may decrease productivity of the adhesive tape 1, which may problematically increase the price.

The adhesive tape 1 in the embodiment may include a primer layer between the supporting body 2 and the adhesive layer 3. The primer layer controls the adhesive material so as not to move to the supporting body 2, and the adhesive layer 3 and the supporting body 2 are therefore less likely to be separated from each other. The primer layer contains rubber components such as polyurethane rubber and natural rubber having methyl methacrylate grafted. The rubber component may be used singly or in mixture of two or more types.

The adhesive tape 1 in the embodiment is usually fabricated as an elongated tape having a width of, for example, between 10 mm and 50 mm inclusive and as a roll tape wound around a core.

When the adhesive tape 1 in the embodiment is heated at 100 degrees C. for 1000 hours in the air, the color difference between the adhesive tapes 1 before and after heating measured in accordance with JIS Z 8722, the condition c, is usually less than 25. In this manner, the adhesive tape 1 of this embodiment less discolors despite being exposed to high temperatures for a long time. The adhesive tape 1 of this embodiment usually has adhesivity of equal to or greater than 1.5 N/10 mm, which is measured in accordance with JIS C 2107, the page 11. As described above, the adhesive tape 1 in this embodiment has excellent adhesivity.

Of the adhesive tapes 1 of the embodiment, an orange adhesive tape 1 having the L*, a*, values in the above-described ranges is preferably used for a wire harness with high-voltage electric wires bundled. A high-voltage electric wire applying a high voltage of larger than 35 volts and equal to or less than 600 volts in AC power supply and a high voltage of larger than 60 volts and equal to or less than 750 volts in DC power supply is obliged to carry an orange sign as a warning color for safety by UNECE. For this obligation, in manufacturing a wire harness by bundling high-voltage electric wires, the adhesive tape 1 in orange needs to be put around the wires. When an accident occurs that causes the wire harness to be exposed to high temperatures, the adhesive tape 1 can be easily distinguished in handling the accident because of its less discoloration. The wire harness with high-voltage electric wires bundled can be therefore easily distinguished. Not only after an accident but upon necessity of working on a place exposed to high temperatures for a long time such as an engine room, the adhesive tape 1 can be easily distinguished because of its less discoloration. The wire harness with high-voltage electric wires bundled can be therefore easily distinguished.

Of the adhesive tapes 1 in the embodiment, a yellow adhesive tape 1 is preferably used for a wire harness for an air bag. Electric wires for an air bag are obliged to carry yellow signs thereon for safety by JASO standard. For this obligation, in manufacturing a wire harness by bundling high-voltage electric wires for an air bag, the adhesive tape 1 in yellow needs to be put around the wires. When the wire harness for an air bag is exposed to high temperatures for a long time, the wire harness can be easily distinguished because of less discoloration of the adhesive tape 1.

The adhesive tape 1 in the embodiment is fabricated, for example, in the following process. Polyvinyl chloride, and as necessary, a pigment, a filler, a stabilizer, and a plasticizer in respective amounts described as above are blended and kneaded together to obtain a mixture. The mixture is formed in a wide film having the above-described thickness, thereby obtaining the supporting body 2. A (meth)acrylic polymer is formed by polymerizing the above-described monomers, thereby obtaining a (meth)acrylic polymer emulsion. In polymerization, monomers are used in the amounts corresponding to the above-described ratio between structural units. The ratio by weight between monomers used for polymerization is usually retained in the polymer. Furthermore, a rubber polymer emulsion (latex) is prepared. Latex of concentrated natural rubber and latex of peroxide-prevulcanized natural rubber can be used as natural rubber. Tackifier resin, an anti-aging agent, and a thickener may be in the form of dispersed liquid. (Meth)acrylic polymer emulsion, rubber polymer emulsion, the tackifier resin, and as necessary, an anti-aging agent, and a thickener are blended in a manner having the respective solid contents in the above-described amounts and stirred, thereby obtaining coating liquid. The coating liquid is coated and dried on the supporting body 2 such that the supporting body 2 has the above-described thickness when dried, and the adhesive layer 3 is thereafter laminated on the supporting body 2. The supporting body 2 having the adhesive layer 3 laminated thereon is wound around a core by a certain length, whereby a wide roll tape is formed. The roll tape is cut in a certain width, whereby the adhesive tape 1 for ordinary use is fabricated.

If the adhesive tape 1 in the embodiment has a primer layer, the above-described latex of a rubber component is coated and dried on the supporting body 2, thereby forming a primer layer. The coating liquid is coated and dried on the primer layer formed on the supporting body 2, and the adhesive layer 3 is thereafter laminated on the supporting body 2.

Wire Harness

A wire harness in the embodiment includes a covered electric wire, and the adhesive tape 1 having the supporting body 2 containing polyvinyl chloride and the adhesive layer 3 containing a (meth)acrylic polymer, a rubber polymer, and tackifier resin. In the adhesive tape 1, the degree of polymerization of polyvinyl chloride is between 1250 and 1800 inclusive, and the (meth)acrylic polymer contains no nitrogen atoms. More specifically, a plurality of covered electric wires in the wire harness of the embodiment are bundled with the adhesive tape 1 wound around the wires. Even when the wire harness is routed on a place such as an engine room, which is to be exposed to high temperatures for a long time, and is exposed to high temperatures for a long time, the wound adhesive tape 1 less discolors. Furthermore, in a case where a wire harness including high-voltage electric wires having the above-described orange adhesive tape 1 wound therearound is routed on a place exposed to high temperatures for a long time, upon necessity of handling the place, the wire harness is easily distinguished because of less discoloration of the adhesive tape 1.

Even when a wire harness for an air bag including a plurality of electric wires having the above-described yellow adhesive tape 1 wound therearound is exposed to high temperatures for a long time, the wire harness can be easily distinguished because of less discoloration of the adhesive tape 1.

The above-described adhesive tape 1 in the embodiment is preferably used, for example, for bundling covered electric wires in home appliances, mechanical products, and others. In any cases, the adhesive tape 1 in the embodiment less discolors even when used in a place exposed to high temperatures for a long time.

### EXAMPLES

### First Example

40 parts by mass of 2-ethylhexyl acrylate, 40 parts by mass of butyl acrylate, and 20 parts by mass of methyl methacrylate were polymerized, and a (meth)acrylic polymer emulsion was fabricated. The (meth)acrylic polymer is considered to contain structural units derived from 2-ethylhexyl acrylate in an amount of 40% by mass, structural units derived from butyl acrylate in an amount of 40% by mass, and structural units derived from methyl methacrylate in an amount of 20% by mass with the total amount of all the structural units taken as 100% by mass. 40 parts by mass (solid content concentration 50% by mass) of a natural rubber emulsion (HA Latex of Regitex Co., Ltd.), 40 parts by mass (solid content concentration 55% by mass) of tackifier resin (E726 of Arakawa Chemical Industries, Ltd.), two parts by mass (solid content concentration 50% by mass) of an anti-aging agent (Selosol K-319 of Chukyo Yushi Co., Ltd.), and one part by mass (solid content concentration 30% by mass) of a thickener (TT615 of Rohm and Haas Chemicals LLC) were added to 20 parts by mass (solid content concentration 50% by mass) of the (meth)acrylic polymer emulsion and stirred by a stirrer, whereby coating liquid was obtained. The coating liquid was applied to the supporting body 2 formed of a flexible polyvinyl chloride film such that the adhesive layer 3 had a thickness of 0.015 mm after dried. In the flexible polyvinyl chloride film, the degree of polymerization of polyvinyl chloride was 1250, and the film had a thickness of 0.10 mm. The supporting body 2 with the coating liquid applied thereto was dried, and the adhesive tape 1 having the adhesive layer 3 was fabricated.

### Second Example

In this example, the adhesive tape 1 was fabricated in the same process as that of the first example except that the flexible polyvinyl chloride film had the degree of polymerization of polyvinyl chloride at 1800 and had a thickness of 0.10 mm.

### First Comparative Example

In this comparative example, an adhesive tape was fabricated in the same process as that of the first example except that the flexible polyvinyl chloride film had the degree of polymerization of polyvinyl chloride at 1050 and had a thickness of 0.10 mm.

### Second Comparative Example

40 parts by mass of 2-ethylhexyl acrylate, 40 parts by mass of acrylonitrile, and 20 parts by mass of methyl methacrylate were polymerized, and a (meth)acrylic polymer emulsion was fabricated. The (meth)acrylic polymer is considered to contain structural units derived from 2-ethylhexyl acrylate in an amount of 40% by mass, structural units derived from acrylonitrile in an amount of 40% by mass, and structural units derived from methyl methacrylate in an amount of 20% by mass with the total amount of all the structural units taken as 100% by mass. 40 parts by mass (solid content concentration 50% by mass) of a natural rubber emulsion (HA Latex of Regitex Co., Ltd.), 40 parts by mass (solid content concentration 55% by mass) of tackifier resin (E726 of Arakawa Chemical Industries, Ltd.), two parts by mass (solid content concentration 50% by mass) of an anti-aging agent (Selosol K-319 of Chukyo Yushi Co., Ltd.), and one part by mass (solid content concentration 30% by mass) of a thickener (TT615 of Rohm and Haas Chemicals LLC) were added to 20 parts by mass (solid content concentration 50% by mass) of the (meth)acrylic polymer emulsion and stirred by a stirrer, whereby coating liquid was obtained. The coating liquid was applied to a supporting body formed of a flexible polyvinyl chloride film such that the adhesive layer had a thickness of 0.015 mm after dried. In the flexible polyvinyl chloride film, the degree of polymerization of polyvinyl chloride was 1250, and the film had a thickness of 0.10 mm. The supporting body with the coating liquid applied thereto was dried, and an adhesive tape having an adhesive layer was fabricated.

### Third Comparative Example

In this example, an adhesive tape was fabricated in the same process as that of the second comparative example except that the flexible polyvinyl chloride film had the degree of polymerization of polyvinyl chloride at 1800 and had a thickness of 0.10 mm.

### Fourth Comparative Example

40 parts by mass of 2-ethylhexyl acrylate, 40 parts by mass of butyl acrylate, and 20 parts by mass of methyl methacrylate were polymerized, and a (meth)acrylic polymer emulsion was fabricated. The (meth)acrylic polymer is considered to contain structural units derived from 2-ethylhexyl acrylate in an amount of 40% by mass, structural units derived from butyl acrylate in an amount of 40% by mass, and structural units derived from methyl methacrylate in an amount of 20% by mass with the total amount of all the structural units taken as 100% by mass. Two parts by mass (solid content concentration 50% by mass) of an anti-aging agent (Selosol K-319 of Chukyo Yushi Co., Ltd.) and one part by mass (solid content concentration 30% by mass) of a thickener (TT615 of Rohm and Haas Chemicals LLC) were added to 100 parts by mass (solid content concentration 50% by mass) of the (meth)acrylic polymer emulsion and stirred by a stirrer, whereby coating liquid was obtained. The coating liquid was applied to a supporting body formed of a flexible polyvinyl chloride film such that the adhesive layer had a thickness of 0.015 mm after dried. In the flexible polyvinyl chloride film, the degree of polymerization of polyvinyl chloride was 1800, and the film had a thickness of 0.10 mm. The supporting body with the coating liquid applied thereto was dried, and an adhesive tape having an adhesive layer was fabricated.

### Fifth Comparative Example

40 parts by mass of 2-ethylhexyl acrylate, 40 parts by mass of acrylonitrile, and 20 parts by mass of methyl methacrylate were polymerized, and a (meth)acrylic polymer emulsion was fabricated. The (meth)acrylic polymer is considered to contain structural units derived from 2-ethylhexyl acrylate in an amount of 40% by mass, structural units derived from acrylonitrile in an amount of 40% by mass, and structural units derived from methyl methacrylate in an amount of 20% by mass with the total amount of all the structural units taken as 100% by mass. Two parts by mass (solid content concentration 50% by mass) of an anti-aging agent (Selosol K-319 of Chukyo Yushi Co., Ltd.) and one part by mass (solid content concentration 30% by mass) of a thickener (TT615 of Rohm and Haas Chemicals LLC) were added to 100 parts by mass (solid content concentration 50% by mass) of the (meth)acrylic polymer emulsion and stirred by a stirrer, whereby coating liquid was obtained. The coating liquid was applied to a supporting body formed of a flexible polyvinyl chloride film such that the adhesive layer had a thickness of 0.015 mm after dried. In the flexible polyvinyl chloride film, the degree of polymerization of polyvinyl chloride was 1800, and the film had a thickness of 0.10 mm. The supporting body with the coating liquid applied thereto was dried, and an adhesive tape having an adhesive layer was fabricated.

### Sixth Comparative Example

50 parts by mass (solid content concentration 50% by mass) of a natural rubber emulsion (HA Latex of Regitex Co., Ltd.), 50 parts by mass (solid content concentration 55% by mass) of tackifier resin (E726 of Arakawa Chemical Industries, Ltd.), two parts by mass (solid content concentration 50% by mass) of an anti-aging agent (Selosol K-319 of Chukyo Yushi Co., Ltd.), and one part by mass (solid content concentration 30% by mass) of a thickener (TT615 of Rohm and Haas Chemicals LLC) were added and stirred by a stirrer, whereby coating liquid was obtained. The coating liquid was applied to a supporting body formed of a flexible polyvinyl chloride film such that the adhesive layer had a thickness of 0.015 mm after dried. In the flexible polyvinyl chloride film, the degree of polymerization of polyvinyl chloride was 1800, and the film had a thickness of 0.10 mm. The supporting body with the coating liquid applied thereto was dried, and an adhesive tape having an adhesive layer was fabricated.

### Seventh Comparative Example

In this comparative example, only a supporting body formed of a flexible polyvinyl chloride film was used. In the flexible polyvinyl chloride film, the degree of polymerization of polyvinyl chloride was 1250, and the film had a thickness of 0.10 mm.

### Eighth Comparative Example

In this comparative example, only a supporting body formed of a flexible polyvinyl chloride film was used. In the flexible polyvinyl chloride film, the degree of polymerization of polyvinyl chloride was 1800, and the film had a thickness of 0.10 mm.

Method of Evaluation

Samples of adhesive tapes fabricated in the examples and the comparative examples were evaluated in adhesivity and color difference. Adhesivity was measured in accordance with JIS C 2107, page 11. In the evaluation, adhesivity equal to or greater than 1.5 N/10 mm was represented by a circle (o), whereas adhesivity smaller than 1.5 N/10 mm was represented by a cross (×). With regards to color difference, an adhesive tape was attached to a PET film and heated at 100 degrees C. for 1000 hours in the air. The color difference between the adhesive tapes before and after heating was measured in accordance with JIS Z 8722, the condition c. The color difference equal to or greater than zero and smaller than ten was represented by a double circle (⊙), the color difference equal to or greater than 10 and smaller than 25 was represented by a circle (o), the color difference equal to or greater than 25 and smaller than 40 was represented by a triangle (Δ), and the color difference equal to or greater than 40 was represented by a cross (×). The results of the evaluations are indicated in Table 1. In Table 1, the amount (part by mass) of a solid content is given as the amount of a composition contained in the adhesive layer.

TABLE 1

| | | | | First | Second | Third | Fourth | Fifth | Sixth | Seventh | Eighth |
|---|---|---|---|---|---|---|---|---|---|---|---|
| | | | | compar- | compar- | compar- | compar- | compar- | compar- | compar- | compar- |
| | | First | Second | ative | ative | ative | ative | ative | ative | ative | ative |
| | | example | example | example | example | example | example | example | example | example | example |
| Adhesive | Natural rubber | 20 | 20 | 20 | 20 | 20 | | | 25 | | |
| layer | (part by mass) | | | | | | | | | | |
| | Tackifier resin | 22 | 22 | 22 | 22 | 22 | | | 27.5 | | |
| | (part by mass) | | | | | | | | | | |
| | Acrylic adhesive | 10 | 10 | 10 | | | 50 | | | | |
| | material (2EHA/ | | | | | | | | | | |
| | BA/MMA) | | | | | | | | | | |
| | (part by mass) | | | | | | | | | | |
| | Acrylic adhesive | | | | 10 | 10 | | 50 | | | |
| | material (2EHA/ | | | | | | | | | | |
| | AN/MMA) | | | | | | | | | | |
| | (part by mass) | | | | | | | | | | |
| | Anti-aging agent | 1 | 1 | 1 | 1 | 1 | 1 | 1 | 1 | | |
| | (part by mass) | | | | | | | | | | |
| | Thickener | 0.3 | 0.3 | 0.3 | 0.3 | 0.3 | 0.3 | 0.3 | 0.3 | | |
| | (part by mass) | | | | | | | | | | |
| Supporting | Degree of | 1250 | 1800 | 1050 | 1250 | 1800 | 1800 | 1800 | 1800 | 1250 | 1800 |
| body | polymerization | | | | | | | | | | |
| Evaluation | Adhesivity | ◯ | ◯ | ◯ | ◯ | ◯ | X | X | X | — | — |
| items | Color difference | ◯ | ⊚ | Δ | X | X | ⊚ | X | ⊚ | ⊚ | ⊚ |
| | (100 degrees | | | | | | | | | | |
| | C. × 1000 | | | | | | | | | | |
| | hours later) | | | | | | | | | | |

An adhesive tape of the present embodiment exerts advantageous effects in less discoloring despite being exposed to high temperatures for a long time.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An adhesive tape comprising:
a supporting body containing polyvinyl chloride; and
an adhesive layer containing a (meth)acrylic polymer, a rubber polymer, and tackifier resin, wherein
a degree of polymerization of the polyvinyl chloride is between 1250 and 1800 inclusive, and the (meth)acrylic polymer contains no nitrogen atoms.

2. The adhesive tape according to claim 1, wherein
the (meth)acrylic polymer contains a structural unit derived from at least a type of monomer selected from the group consisting of methyl acrylate, ethyl acrylate, 2-ethylhexyl acrylate, butyl acrylate, 2-hydroxyethyl acrylate, methyl methacrylate, and 2-hydroxyethyl methacrylate.

3. The adhesive tape according to claim 1, wherein
the (meth)acrylic polymer contains a structural unit derived from 2-ethylhexyl acrylate in an amount of between 30% and 50% inclusive by mass, a structural unit derived from butyl acrylate in an amount of between 30% and 50% inclusive by mass, and a structural unit derived from methyl methacrylate in an amount of between 10% and 40% inclusive by mass with a total amount of the structural unit derived from 2-ethylhexyl acrylate, the structural unit derived from butyl acrylate, and the structural unit derived from methyl methacrylate taken as 100% by mass.

4. The adhesive tape according to claim 1, wherein
in color evaluation using L*, a*, b* system (CIE colorimetric system), the adhesive tape has L* between 40 and 70 inclusive, between 35 and 60 inclusive, and b* between 30 and 60 inclusive.

5. The adhesive tape according to claim 2, wherein
in color evaluation using L*, a*, b* system (CIE colorimetric system), the adhesive tape has L* between 40 and 70 inclusive, between 35 and 60 inclusive, and b* between 30 and 60 inclusive.

6. The adhesive tape according to claim 3, wherein
in color evaluation using L*, a*, b* system (CIE colorimetric system), the adhesive tape has L* between 40 and 70 inclusive, between 35 and 60 inclusive, and b* between 30 and 60 inclusive.

7. The adhesive tape according to claim 1, wherein
when the adhesive tape is heated at 100 degrees C. for 1000 hours, a color difference between adhesive tapes before and after heating is less than 25.

8. The adhesive tape according to claim 2, wherein
when the adhesive tape is heated at 100 degrees C. for 1000 hours, a color difference between adhesive tapes before and after heating is less than 25.

9. The adhesive tape according to claim 3, wherein
when the adhesive tape is heated at 100 degrees C. for 1000 hours, a color difference between adhesive tapes before and after heating is less than 25.

10. The adhesive tape according to claim 4, wherein
when the adhesive tape is heated at 100 degrees C. for 1000 hours, a color difference between adhesive tapes before and after heating is less than 25.

11. The adhesive tape according to claim 5, wherein
when the adhesive tape is heated at 100 degrees C. for 1000 hours, a color difference between adhesive tapes before and after heating is less than 25.

12. The adhesive tape according to claim 6, wherein
when the adhesive tape is heated at 100 degrees C. for 1000 hours, a color difference between adhesive tapes before and after heating is less than 25.

13. A wire harness comprising:
a covered electric wire; and
an adhesive tape including a supporting body containing polyvinyl chloride and an adhesive layer containing a (meth)acrylic polymer, a rubber polymer, and tackifier resin, a degree of polymerization of the polyvinyl chloride being between 1250 and 1800 inclusive, and the (meth)acrylic polymer containing no nitrogen atoms.
